(19) United States
(12) Patent Application Publication
(10) Pub. No.: US 2021/0003219 A1
(43) Pub. Date: Jan. 7, 2021

(54) SEAL MEMBER AND SWIVEL JOINT

(71) Applicant: Komatsu Ltd., Tokyo (JP)

(72) Inventors: Satoshi Michikami, Tokyo (JP); Hideshi Iitani, Tokyo (JP)

(73) Assignee: Komatsu Ltd., Tokyo (JP)

(21) Appl. No.: 16/979,342

(22) PCT Filed: May 21, 2019
(86) PCT No.: PCT/JP2019/020179

§ 371 Date: Sep. 9, 2020

(30) Foreign Application Priority Data
May 31, 2018 (JP) 2018-105662

(51) Int. Cl. F16J 15/18; F16L 27/087

(52) U.S. Cl. CPC F16J 15/18; E02F 9/006; F16L 27/087

(57) ABSTRACT

A seal member includes: an inner circumferential surface surrounding a central axis; an upper surface connected to one end of the inner circumferential surface in an axial direction of the central axis; a lower surface connected to another end of the inner circumferential surface in the axial direction; and a protrusion that is provided continuously to the inner circumferential surface so as to surround the central axis and that includes a first portion inclined to the upper surface side toward one side in a circumferential direction of the central axis and a second portion inclined to the lower surface side toward the one side in the circumferential direction.

### FIELD

The present invention relates to a seal member and a swivel joint.

### BACKGROUND

A working vehicle such as an excavator includes an upper swing body and a lower carriage. A hydraulic pump is arranged on the upper swing body. A hydraulic motor (travel motor) is arranged on the lower carriage. The upper swing body and the lower carriage are coupled to each other via a swivel joint. Hydraulic oil discharged from the hydraulic pump is supplied to the hydraulic motor via an oil passage provided in the swivel joint. The hydraulic oil discharged from the hydraulic pump is supplied to the hydraulic motor, and this drives the hydraulic motor to move the lower carriage.

### CITATION LIST

### Patent Literature

Patent Literature 1: JP 2017-075647 A

### SUMMARY

### Technical Problem

The swivel joint has a plurality of oil passages. The swivel joint is provided with a seal member to partition between the plurality of oil passages.

Performances required of the seal member include suppression of leakage of hydraulic oil, smooth rotation of the swivel joint with low torque, and capability of maintaining sealability for a long period of time.

In order to suppress the leakage of the hydraulic oil, it is conceivable to increase the fitting margin of the seal member to increase the straining force of the seal member. On the other hand, however, increasing the straining force of the seal member might make it difficult to smoothly rotate the swivel joint with low torque. Moreover, increasing the straining force of the seal member to increase the frictional force acting on the seal member would cause an occurrence of a stick-slip phenomenon in the friction between the seal member and the shaft of the swivel joint, causing abnormal noise or vibration, leading to discomfort to the driver of the working vehicle and damage to the hoses and swivel joints. On the other hand, decreasing the fitting margin of the seal member to reduce the straining force of the seal member would make it difficult to sufficiently suppress the leakage of hydraulic oil or difficult to maintain the sealability for a long period of time.

An aspect of the present invention is to maintain a sealability for a long period of time and to rotate a swivel joint smoothly with low torque.

### Solution to Problem

According to an aspect of the present invention, a seal member comprises: an inner circumferential surface surrounding a central axis; an upper surface connected to one end of the inner circumferential surface in an axial direction of the central axis; a lower surface connected to another end of the inner circumferential surface in the axial direction; and a protrusion that is provided continuously on the inner circumferential surface so as to surround the central axis and that includes a first portion inclined to the upper surface side toward one side in a circumferential direction of the central axis and a second portion inclined to the lower surface side toward the one side in the circumferential direction.

### Advantageous Effects of Invention

According to an aspect of the present invention, it is possible to maintain the sealability for a long period of time and to rotate the swivel joint smoothly with low torque.

### BRIEF DESCRIPTION OF DRAWINGS

FIG. 1 is a view schematically illustrating a working vehicle according to a first embodiment.

FIG. 2 is a side cross-sectional view illustrating a swivel joint according to the first embodiment.

FIG. 3 is a side view illustrating the swivel joint according to the first embodiment.

FIG. 4 is a top view illustrating the swivel joint according to the first embodiment.

FIG. 5 is a perspective view illustrating a seal member according to the first embodiment.

FIG. 6 is an enlarged perspective view of a part of the seal member according to the first embodiment.

FIG. 7 is a developed view of an inner circumferential surface of the seal member according to the first embodiment.

FIG. 8 is a cross-sectional view illustrating a protrusion according to the first embodiment.

FIG. 9 is a view illustrating action of the seal member according to the first embodiment.

FIG. 10 is a cross-sectional view illustrating a protrusion according to a second embodiment.

FIG. 11 is a cross-sectional view illustrating a protrusion according to a third embodiment.

FIG. 12 is an enlarged perspective view of a part of a seal member according to a fourth embodiment.

FIG. 13 is an enlarged perspective view of a part of a seal member according to a fifth embodiment.

### DESCRIPTION OF EMBODIMENTS

Hereinafter, embodiments according to the present invention will be described with reference to the drawings, although the present invention is not limited to the embodiments. It is possible to appropriately combine the constituents described in the embodiments below. In some cases, a portion of the constituents is not utilized.

### [1] First Embodiment

[Working Vehicle]

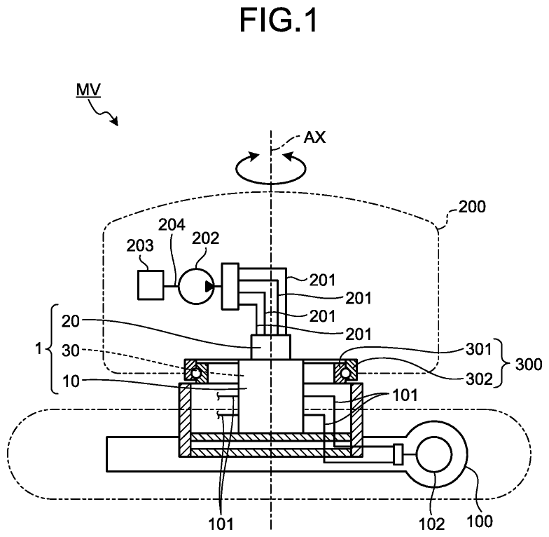

FIG. 1 is a schematic view illustrating a working vehicle MV according to the present embodiment. The working vehicle MV includes a lower carriage 100, an upper swing body 200 rotatably supported by the lower carriage 100, a rotating mechanism 300 coupling the lower carriage 100 with the upper swing body 200, and a swivel joint 1 coupling the lower carriage 100 with the upper swing body 200. Examples of the working vehicle MV include an excavator or a backhoe.

The rotating mechanism 300 includes: an inner ring member 301; and an outer ring member 302 arranged around the inner ring member 301. The inner ring member 301 and the outer ring member 302 relatively rotate about a swing axis AX. The inner ring member 301 is secured to the lower carriage 100. The outer ring member 302 is secured to the upper swing body 200.

The swivel joint 1 has a rotor 10 and a shaft 20 rotatably supported by the rotor 10. The rotor 10 and the shaft 20 relatively rotate about the swing axis AX. The rotor 10 is secured to the lower carriage 100. The shaft 20 is secured to the upper swing body 200. Note that the rotor 10 may be secured to the upper swing body 200 and the shaft 20 may be secured to the lower carriage 100.

The lower carriage 100 and the upper swing body 200 are coupled to each other via the rotating mechanism 300 and the swivel joint 1. The rotating mechanism 300 and the swivel joint 1 allow the upper swing body 200 to swing about the swing axis AX with respect to the lower carriage 100.

The upper swing body 200 includes a hydraulic pump 202 and a hydraulic oil tank 203. The lower carriage 100 includes a hydraulic motor 102. The hydraulic pump 202 and the swivel joint 1 are connected to each other via a tube 201. The swivel joint 1 and the hydraulic motor 102 are connected to each other via a tube 101. The hydraulic oil tank 203 stores hydraulic oil. The hydraulic oil stored in the hydraulic oil tank 203 is supplied to the hydraulic pump 202 via an oil passage 204. The hydraulic pump 202 discharges the hydraulic oil supplied from the hydraulic oil tank 203. The hydraulic oil discharged from the hydraulic pump 202 is supplied to the hydraulic motor 102 via the tube 201, an oil passage 30 provided in the swivel joint 1, and the tube 101. The hydraulic oil discharged from the hydraulic pump 202 is supplied to the hydraulic motor 102. This drives the hydraulic motor 102 to move the lower carriage 100. The hydraulic oil sent from the hydraulic motor 102 is returned to the hydraulic oil tank 203 via an oil passage (not illustrated).

[Swivel Joint]

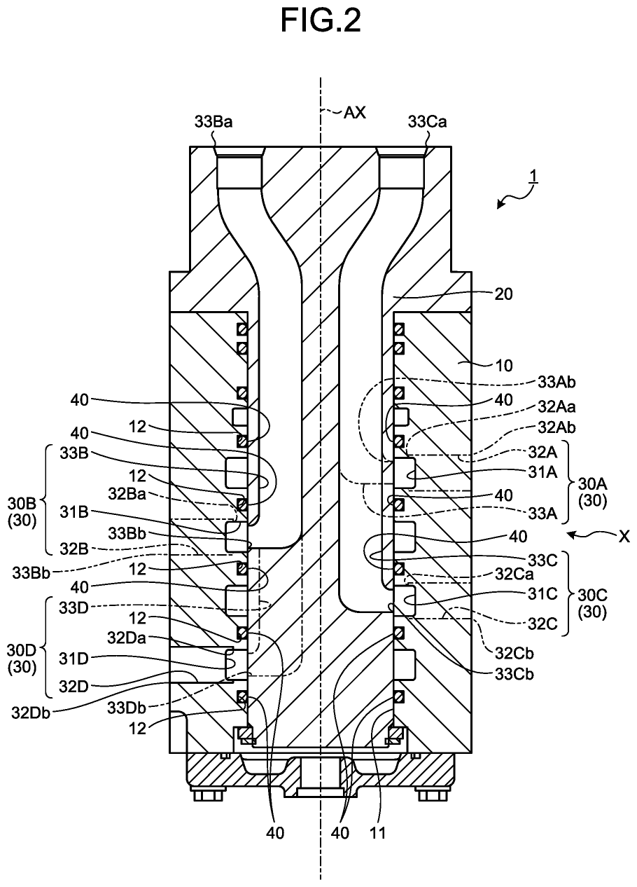

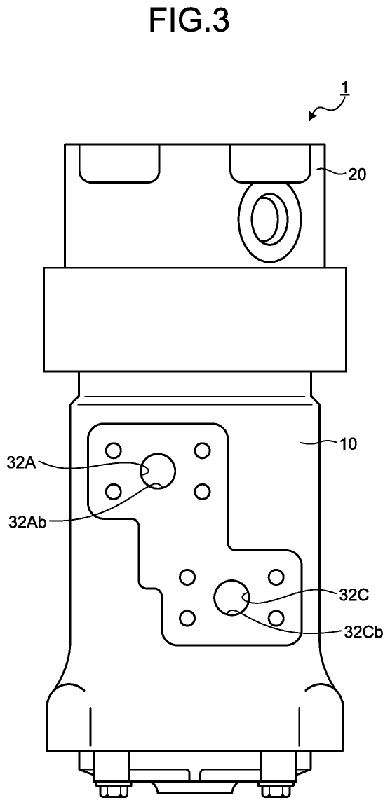

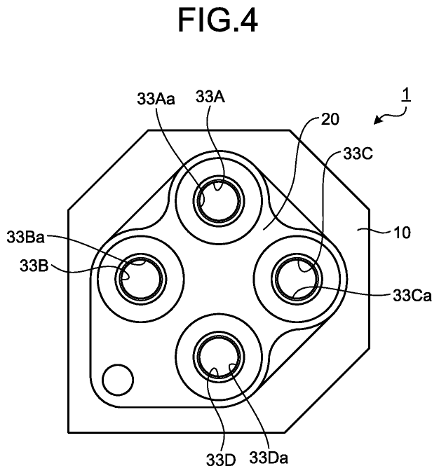

FIG. 2 is a side cross-sectional view illustrating the swivel joint 1 according to the present embodiment. FIG. 3 is a side view illustrating the swivel joint 1 according to the present embodiment. FIG. 4 is a top view illustrating the swivel joint 1 according to the present embodiment. While the present embodiment describes an example in which the swivel joint 1 has four ports, the number of ports may be six or any other number.

The swivel joint 1 includes the rotor 10 having a hole 11, the shaft 20 arranged in the hole 11 of the rotor 10, and a seal member 40 that seals between the rotor 10 and the shaft 20.

The upper end of the hole 11 is open. The lower end of the hole 11 is closed. The upper surface of the rotor 10 has an opening. The shaft 20 is inserted into the hole 11 through the opening provided on the upper surface of the rotor 10. The shaft 20 rotates about the swing axis AX in a state of being arranged inside the hole 11. The hydraulic oil discharged from the hydraulic pump 202 is sent to the hydraulic motor (swing motor) to swing the upper swing body 200 so as to rotate the shaft 20 secured to the upper swing body 200.

The oil passage 30 is provided in plurality. In the present embodiment, the oil passage 30 includes an oil passage 30A, an oil passage 30B, an oil passage 30C, and an oil passage 30D.

The oil passage 30A includes: an annular oil passage 31A provided on the inner circumferential surface of the hole 11 of the rotor 10; a rotor port 32A provided on the rotor 10 so as to connect the annular oil passage 31A and the outer circumferential surface of the rotor 10; and a shaft port 33A provided inside the shaft 20 so as to connect the upper surface of the shaft 20 and the outer circumferential surface of the shaft 20.

The oil passage 30B includes: an annular oil passage 31B provided on the inner circumferential surface of the hole 11 of the rotor 10; a rotor port 32B provided on the rotor 10 so as to connect the annular oil passage 31B and the outer circumferential surface of the rotor 10; and a shaft port 33B provided inside the shaft 20 so as to connect the upper surface of the shaft 20 and the outer circumferential surface of the shaft 20.

The oil passage 30C includes: an annular oil passage 31C provided on the inner circumferential surface of the hole 11 of the rotor 10; a rotor port 32C provided on the rotor 10 so as to connect the annular oil passage 31C and the outer circumferential surface of the rotor 10; and a shaft port 33C provided inside the shaft 20 so as to connect the upper surface of the shaft 20 and the outer circumferential surface of the shaft 20.

The oil passage 30D includes: an annular oil passage 31D provided on the inner circumferential surface of the hole 11 of the rotor 10; a rotor port 32D provided on the rotor 10 so as to connect the annular oil passage 31D and the outer circumferential surface of the rotor 10; and a shaft port 33D provided inside the shaft 20 so as to connect the upper surface of the shaft 20 and the outer circumferential surface of the shaft 20.

Individual oil passages, namely the annular oil passage 31A, the annular oil passage 31B, the annular oil passage 31C, and the annular oil passage 31D, are formed on the inner circumferential surface of the hole 11 so as to surround the swing axis AX. The annular oil passage 31A, the annular oil passage 31B, the annular oil passage 31C, and the annular oil passage 31D are provided at mutually different positions in a direction parallel to the swing axis AX.

One end 32Aa of the rotor port 32A is connected to the annular oil passage 31A. Another end 32Ab of the rotor port 32A is arranged on the outer circumferential surface of the rotor 10. One end 32Ba of the rotor port 32B is connected to the annular oil passage 31B, while another end 32Bb of the rotor port 32B is arranged on the outer circumferential surface of the rotor 10. One end 32Ca of the rotor port 32C is connected to the annular oil passage 31C. Another end 32Cb of the rotor port 32C is arranged on the outer circumferential surface of the rotor 10. One end 32Da of the rotor port 32D is connected to the annular oil passage 31D, while another end 32Db of the rotor port 32D is arranged on the outer circumferential surface of the rotor 10.

One end 33Aa of the shaft port 33A is arranged on the upper surface of the shaft 20. Another end 33Ab of the shaft port 33A is arranged on the outer circumferential surface of the shaft 20 so as to face the annular oil passage 31A. One end 33Ba of the shaft port 33B is arranged on the upper surface of the shaft 20. Another end 33Bb of the shaft port 33B is arranged on the outer circumferential surface of the shaft 20 so as to face the annular oil passage 31B. One end 33Ca of the shaft port 33C is arranged on the upper surface of the shaft 20. Another end 33Cb of the shaft port 33C is arranged on the outer circumferential surface of the shaft 20 so as to face the annular oil passage 31C. One end 33Da of the shaft port 33D is arranged on the upper surface of the shaft 20. Another end 33Db of the shaft port 33D is arranged on the outer circumferential surface of the shaft 20 so as to face the annular oil passage 31D.

One ends 33Aa, 33Ba, 33Ca, and 33Da respectively on the shaft ports 33A, 33B, 33C, and 33D are connected to the tube 201. The shaft ports 33A, 33B, 33C, and 33D are connected to the hydraulic pump 202 via the tube 201.

The other ends 32Ab, 32Bb, 32Cb, and 32Db respectively on the rotor ports 32A, 32B, 32C, and 32D are connected to the tube 101. The rotor ports 32A, 32B, 32C, and 32D are connected to the hydraulic motor 102 via the tube 101.

The hydraulic oil discharged from the hydraulic pump 202 flows through the tube 201 so as to be supplied to the hydraulic motor 102 via at least a part of the oil passages 30A, 30B, 30C or 30D, and via the tube 101. Furthermore, the hydraulic oil from the hydraulic motor 102 flows through the tube 101, and then returned to the hydraulic oil tank 203 provided in the upper swing body 200, via at least a part of the oil passages 30A, 30B, 30C, or 30D, and via the tube 201.

Even when the shaft 20 rotates with respect to the rotor 10, the other end of the shaft port 33A continues to face the annular oil passage 31A. This enables continuous flow of the hydraulic oil through the shaft port 33A, the annular oil passage 31A, and the rotor port 32A. Similarly, even when the shaft 20 rotates with respect to the rotor 10, the other ends of the shaft ports 33B, 33C, and 33D continue to face the annular oil passages 31B, 31C, and 31D, respectively.

The seal member 40 is provided to partition between the plurality of oil passages 30A, 30B, 30C, and 30D. The seal member 40 is an annular member. The seal member 40 is disposed in a groove 12 on the inner circumferential surface of the hole 11. The groove 12 is formed on the inner circumferential surface of the hole 11 so as to surround the swing axis AX. In the direction parallel to the swing axis AX, the groove 12 is located in individual positions, namely, above the annular oil passage 31A, between the annular oil passage 31A and the annular oil passage 31B, between the annular oil passage 31B and the annular oil passage 31C, between the annular oil passage 31C and the annular oil passage 31D, and below the annular oil passage 31D. The seal member 40 is arranged in each of the plurality of grooves 12.

The seal member 40 comes in contact with the outer circumferential surface of the shaft 20, in a state being arranged in the groove 12. The seal member 40 arranged between the annular oil passage 31A and the annular oil passage 31B seals between the oil passage 30A and the oil passage 30B so as to prevent entry of the hydraulic oil flowing in the annular oil passage 30A to the annular oil passage 30B, and prevent entry of the hydraulic oil flowing in the oil passage 30B to the oil passage 30A. Similarly, the seal member 40 arranged between the annular oil passage 31B and the annular oil passage 31C seals between the oil passage 30B and the oil passage 30C. The seal member 40 arranged between the annular oil passage 31C and the annular oil passage 31D seals between the oil passage 30C and the oil passage 30D. The seal member 40 disposed above the annular oil passage 31A seals the oil passage 30A to suppress leakage of hydraulic oil from between the rotor 10 and the shaft 20. The seal member 40 disposed below the annular oil passage 31D seals the oil passage 30D to suppress leakage of hydraulic oil from between the rotor 10 and the shaft 20.

[Seal Member]

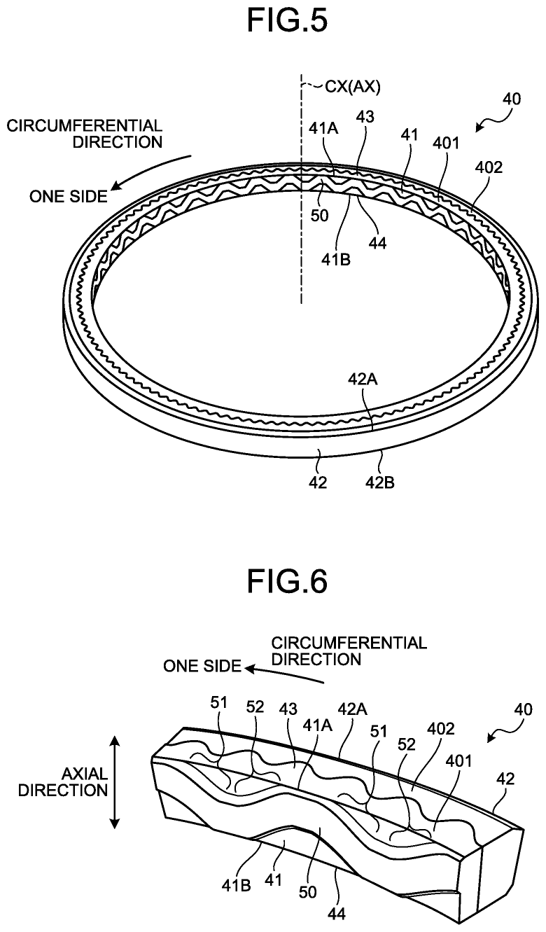

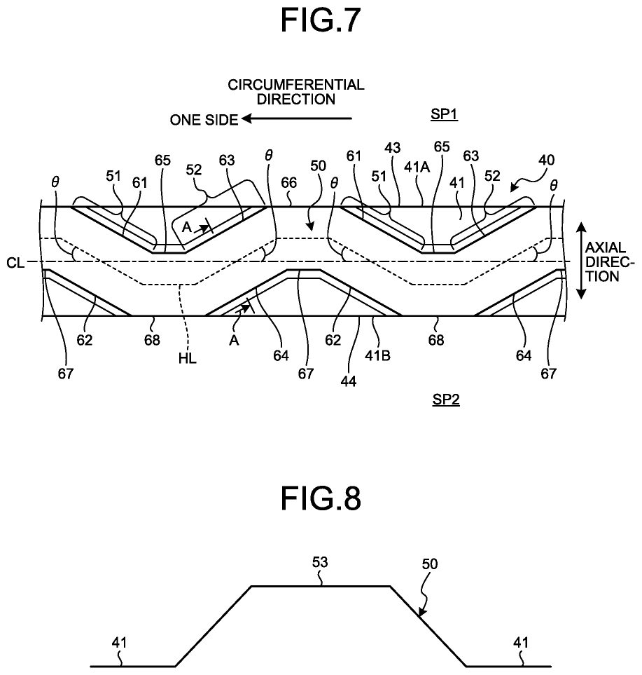

FIG. 5 is a perspective view illustrating the seal member 40 according to the present embodiment. FIG. 6 is an enlarged perspective view of a part of the seal member 40 according to the present embodiment. FIG. 7 is a developed view of an inner circumferential surface 41 of the seal member 40 according to the present embodiment.

The seal member 40 is an annular member disposed around a central axis CX. In a state where the seal member 40 is disposed in the groove 12, the central axis CX of the seal member 40 and the swing axis AX are aligned with each other.

The seal member 40 includes: the inner circumferential surface 41 surrounding the central axis CX; an outer circumferential surface 42 facing the opposite side of the inner circumferential surface 41; an upper surface 43 connected to one end 41A of the inner circumferential surface 41 in the axial direction of the central axis CX; a lower surface 44 connected to another end 41B of the inner circumferential surface 41 in the axial direction; and a protrusion 50 provided on the inner circumferential surface 41.

The upper surface 43 connects the one end 41A of the inner circumferential surface 41 and one end 42A of the outer circumferential surface 42. The one end 41A of the inner circumferential surface 41 is the upper end of the inner circumferential surface 41, while the one end 42A of the outer circumferential surface 42 is the upper end of the outer circumferential surface 42.

The lower surface 44 connects the other end 41B of the inner circumferential surface 41 and another end 42B of the outer circumferential surface 42. The other end 41B of the inner circumferential surface 41 is the lower end of the inner circumferential surface 41, while the other end 42B of the outer circumferential surface 42 is the lower end of the outer circumferential surface 42.

The protrusion 50 is provided on the inner circumferential surface 41 and protrudes from the inner circumferential surface 41 toward the central axis CX. The protrusion 50 comes in contact with the outer circumferential surface of the shaft 20 in a state where the seal member 40 is disposed in the groove 12. The protrusion 50 is continuously provided on the inner circumferential surface 41 so as to surround the central axis CX. The protrusion 50 is provided on the inner circumferential surface 41 so as to partition between a first space SP1 and a second space SP2, in the axial direction. As illustrated in FIG. 7, the first space SP1 is a space (upper space) on one side from the protrusion 50 in the axial direction, being a space including the one end 41A. The second space SP2 is a space on the other side from the protrusion 50 (a space below), being a space including the other end 41B.

For example, the protrusion 50 of the seal member 40 arranged between the annular oil passage 31A and the annular oil passage 31B comes in contact with the outer circumferential surface of the shaft 20, and thereby partitions between the first space SP1 including the oil passage 30A and the second space SP2 including the oil passage 30B so as to suppress the flow of hydraulic oil from one of the first space SP1 and the second space SP2 to the other.

Similarly, the protrusion 50 of the seal member 40 arranged between the annular oil passage 31B and the annular oil passage 31C comes in contact with the outer circumferential surface of the shaft 20, and thereby partitions between the first space SP1 including the oil passage 30B and the second space SP2 including the oil passage 30C so as to suppress the flow of hydraulic oil from one of the first space SP1 and the second space SP2 to the other. The protrusion 50 of the seal member 40 arranged between the annular oil passage 31C and the annular oil passage 31D comes in contact with the outer circumferential surface of the shaft 20, and thereby partitions between the first space SP1 including the oil passage 30C and the second space SP2 including the oil passage 30D so as to suppress the flow of hydraulic oil from one of the first space SP1 and the second space SP2 to the other.

That is, the protrusion 50 is continuously provided in the circumferential direction of the central axis CX so as to avoid formation of a gap between the protrusion 50 and the shaft 20.

As illustrated in FIG. 7, the protrusion 50 includes: a first portion 51 inclined to the upper surface 43 side toward one side in the circumferential direction of the central axis CX; and a second portion 52 inclined to the lower surface 44 side toward the one side in the circumferential direction.

The first portion 51 and second portion 52 are provided in plurality, alternately in the circumferential direction.

The first portion 51 is defined by a first edge 61 and a second edge 62 that are inclined to the upper surface 43 side toward one side in the circumferential direction. The first edge 61 and the second edge 62 are parallel to each other. The first edge 61 and the second edge 62 are formed in straight lines.

The second portion 52 is defined by a third edge 63 and a fourth edge 64 that are inclined to the lower surface 44 side toward one side in the circumferential direction. The third edge 63 and the fourth edge 64 are parallel to each other. The third edge 63 and the fourth edge 64 are formed in straight lines.

The first edge 61 and the third edge 63 are arranged on the one end 41A side from a center line CL between the one end 41A and the other end 41B of the inner circumferential surface 41. The second edge 62 and the fourth edge 64 are arranged on the other end 41B side from the center line CL. That is, the center line CL passes through the protrusion 50. The center line CL refers to a line that passes through the central position between the one end 41A and the other end 41B in the axial direction and extends in the circumferential direction.

The first edge 61 and the third edge 63 close to the center line CL are connected via a fifth edge 65. The fifth edge 65 is parallel to the center line CL.

The first edge 61 and the third edge 63 far from the center line CL are connected via a sixth edge 66. The sixth edge 66 is parallel to the center line CL.

The second edge 62 and the fourth edge 64 close to the center line CL are connected via the seventh edge 67. The seventh edge 67 is parallel to the center line CL.

The second edge 62 and the fourth edge 64 far from the center line CL are connected via an eighth edge 68. The eighth edge 68 is parallel to the center line CL.

In the circumferential direction, the fifth edge 65, which is a boundary between the first edge 61 and the third edge 63, is arranged between the two seventh edges 67, each of which being a boundary between the second edge 62 and the fourth edge 64. Furthermore, in the circumferential direction, the sixth edge 66, which is a boundary between the first edge 61 and the third edge 63, is arranged between the two eighth edges 68, each of which being a boundary between the second edge 62 and the fourth edge 64.

That is, in the present embodiment, the protrusion 50 is provided in a zigzag in the circumferential direction of the central axis CX. The first portion 51 between the first edge 61 and the second edge 62 is formed in a strip shape. The second portion 52 between the third edge 63 and the fourth edge 64 is formed in a strip shape.

A center line HL is defined for each of portions, namely, the first portion 51 and the second portion 52. The center line HL of the first portion 51 is a line that passes through the center position between the first edge 61 and the second edge 62 and is parallel to both the first edge 61 and the second edge 62. The center line HL of the second portion 52 is a line that passes through the center position between the third edge 63 and the fourth edge 64 and is parallel to both the third edge 63 and the fourth edge 64. Both the center line HL of the first portion 51 and the center line HL of the second portion 52 are inclined with respect to the direction perpendicular to the central axis CX. In the present embodiment, an inclination angle θ of the center line HL with respect to the rotational direction of the shaft 20 is 45[° ] or less.

The inclination angle θ of the center line HL of the first portion 51 is a same angle for each of the plurality of first portions 51 arranged in the circumferential direction. The inclination angle θ of the center line HL of the second portion 52 is a same angle for each of the plurality of second portions 52 arranged in the circumferential direction. The inclination angle θ of the center line HL of the first portion 51 is equal to the inclination angle θ of the center line HL of the second portion 52.

In addition, in each of the plurality of first portions 51 arranged in the circumferential direction, the lengths of the first edges 61 are the same, and the lengths of the second edges 62 are the same. In each of the plurality of second portions 52 arranged in the circumferential direction, the lengths of the third edges 63 are the same and the lengths of the fourth edges 64 are the same.

That is, in the present embodiment, the protrusions 50 are provided in a zigzag at a uniform pitch in the circumferential direction of the central axis CX.

As illustrated in FIGS. 5 and 6, the seal member 40 includes: an inner circumferential ring member 401; and an outer circumferential ring member 402 arranged around the inner circumferential ring member 401. That is, the seal member 40 is formed with two ring members. The inner circumferential ring member 401 includes the inner circumferential surface 41, the protrusion 50, a part of the upper surface 43, and a part of the lower surface 44. The outer circumferential ring member 402 includes the outer circumferential surface 42, a part of the upper surface 43, and a part of the lower surface 44.

The outer circumferential ring member 402 is formed of a material having a hardness lower than a hardness of the inner circumferential ring member 401. The inner circumferential ring member 401 is formed of synthetic resin. The outer circumferential ring member 402 is formed of either synthetic resin or rubber having a hardness lower than the hardness of the inner circumferential ring member 401. In the present embodiment, the inner circumferential ring member 401 is formed of nylon resin, and the outer circumferential ring member 402 is formed of urethane resin.

FIG. 8 is a cross-sectional view illustrating the protrusion 50 according to the present embodiment and corresponds to a view taken along line A-A of FIG. 7. As illustrated in FIG. 8, a contact surface 53 of the protrusion 50 that comes into contact with the outer circumferential surface of the shaft 20 is flat in cross section. This enables the protrusion 50 to be sufficiently in contact with the outer circumferential surface of the shaft 20.

[Action]

The protrusion 50 of the seal member 40 includes the first portion 51 and the second portion 52. Therefore, when the shaft 20 rotates with respect to the rotor 10 and the seal member 40 in a state where the seal member 40 and the shaft 20 are in contact with each other, it is possible to suppress an occurrence of a stick-slip phenomenon, achieving smooth rotation of the swivel joint 1 with low torque.

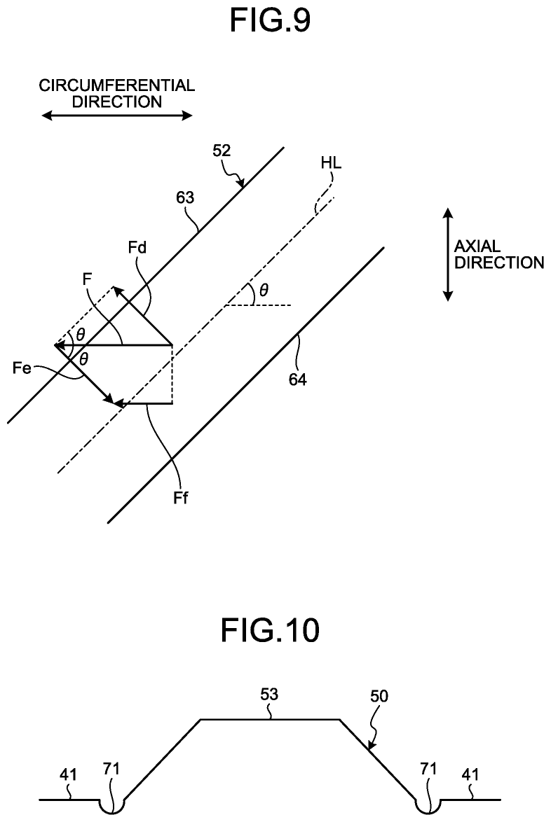

FIG. 9 is a view illustrating actions of the seal member 40 according to the present embodiment, being an enlarged view of the second portion 52 of the protrusion 50. The second portion 52 is a strip-shaped portion defined by the third edge 63 and the fourth edge 64 arranged in parallel to each other. When the shaft 20 rotates while the protrusion 50 is in contact with the outer circumferential surface of the shaft 20, a frictional force F with the shaft 20 acts on the second portion 52. The frictional force F acts in the rotational direction of the shaft 20 orthogonal to the central axis CX. The frictional force F corresponds to the product of a friction coefficient μ of the protrusion 50 and a straining force N indicating the force pressing the protrusion 50 against the shaft 20. The greater the fitting margin of the seal member 40 disposed between the groove 12 and the shaft 20, the higher the straining force N.

The center line HL of the second portion 52 is inclined with respect to the rotational direction of the shaft 20. In the present embodiment, an inclination angle θ of the center line HL with respect to the rotational direction of the shaft 20 is 45[° ] or less. In the example illustrated in FIG. 9, the inclination angle θ is 45[⁰]. As described above, the center line HL of the second portion 52 is a line that passes through the center position between the third edge 63 and the fourth edge 64 and is parallel to both the third edge 63 and the fourth edge 64. Based on the frictional force F, a force Fd acts on the second portion 52 in the direction orthogonal to the center line HL. The relationship of [Fd=F×sin θ] is established between the frictional force F and the force Fd.

The protrusion 50 is formed of synthetic resin and is elastically deformable. When the force Fd acts on the second portion 52, the second portion 52 generates an elastic force Fe to resist the force Fd. The direction in which the force Fd acts is opposite to the direction in which the elastic force Fe acts. The frictional force F acting on the second portion 52 of the protrusion 50 decreases to [Ff=F−Fe×cos θ] due to the action of the elastic force Fe.

In this manner, since the second portion 52 generates the elastic force Fe, the force acting on the protrusion 50 in the rotational direction of the shaft 20 is converted to the force Ff, smaller than the frictional force F defined based on the straining force N. This makes it possible to achieve smooth rotation of the swivel joint 1 with low torque.

In the present embodiment, even when the straining force N (fitting margin of the seal member 40) is increased, the force acting in the rotational direction of the shaft 20 is reduced to the force Ff. That is, it is possible to achieve smooth rotation of the swivel joint 1 with a low torque while maintaining the straining force N at a high value. With the possibility of maintaining the straining force N at a high value, it is possible to sufficiently suppress the leakage of hydraulic oil, enabling the sealability to be maintained for a long period of time.

Furthermore, since the force acting in the rotational direction of the shaft 20 is reduced, the occurrence of the stick-slip phenomenon would be suppressed even when the shaft 20 rotates at a low speed, for example.

The action of the second portion 52 when the shaft 20 rotates to one side has been described above. When the shaft 20 rotates to the other side, the second portion 52 also achieves functions similar to those described above. Furthermore, when the shaft 20 rotates, the first portion 51 also exhibits the functions similar to those of the second portion 52.

[Effects]

As described above, according to the present embodiment, since the protrusion 50 includes the first portion 51 and the second portion 52, it is possible to achieve smooth rotation of the shaft 220 of the swivel joint 1 with low torque while maintaining the straining force N at a high value. Furthermore, even when the shaft 20 rotates at a low speed, the occurrence of stick-slip phenomenon would be suppressed. Furthermore, since the straining force N can be maintained at a high value, leakage of hydraulic oil can be sufficiently suppressed, and the sealability can be maintained for a long period of time.

Furthermore, in the present embodiment, the seal member 40 includes: the inner circumferential ring member 401 that comes in contact with the shaft 20; and the outer circumferential ring member 402 arranged around the inner circumferential ring member 401 and formed of a material having a hardness lower than a hardness of the inner circumferential ring member 401. Since the outer circumferential ring member 402 has a low hardness, it is possible to increase the fitting margin of the seal member 40. Since the inner circumferential ring member 401 that comes in contact with the shaft 20 has a high hardness, the sealability can be maintained for a long period of time.

### [2] Second Embodiment

A second embodiment will be described. In the following description, the same components as those in the above-described embodiment are designated by the same reference numerals, and the description thereof will be simplified or omitted.

FIG. 10 is a cross-sectional view illustrating the protrusion 50 according to the present embodiment. As illustrated in FIG. 10, a recess 71 may be formed at a boundary between the protrusion 50 and the inner circumferential surface 41. Forming the recess 71 will increase the elastic deformability of the protrusion 50 in a direction orthogonal to the center line HL. Therefore, the protrusion 50 can sufficiently generate the elastic force Fe for reducing the frictional force F.

### [3] Third Embodiment

A third embodiment will be described. In the following description, the same components as those in the above-described embodiment are designated by the same reference numerals, and the description thereof will be simplified or omitted.

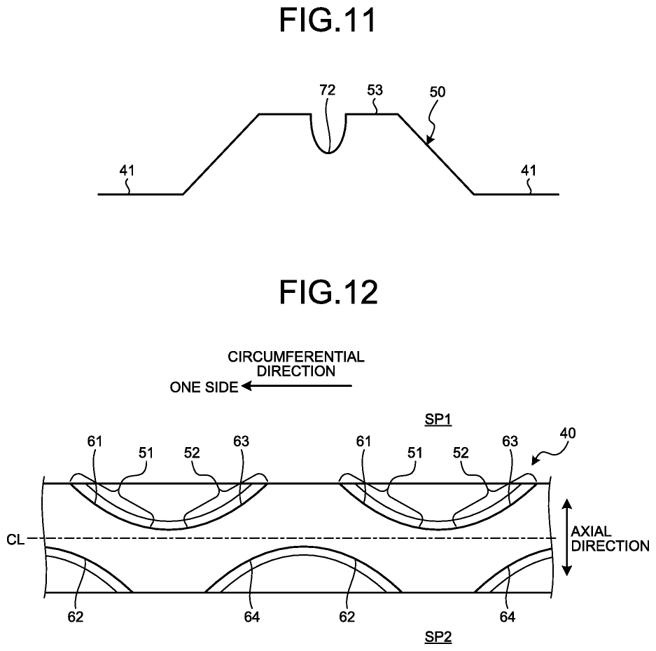

FIG. 11 is a cross-sectional view illustrating the protrusion 50 according to the present embodiment. As illustrated in FIG. 11, a recess 72 may be formed on the contact surface 53 of the protrusion 50. Forming the recess 72 will increase the elastic deformability of the protrusion 50 in the direction orthogonal to the center line HL. Therefore, the protrusion 50 can sufficiently generate the elastic force Fe for reducing the frictional force F.

### [4] Fourth Embodiment

A fourth embodiment will be described. In the following description, the same components as those in the above-described embodiment are designated by the same reference numerals, and the description thereof will be simplified or omitted.

FIG. 12 is an enlarged perspective view of a part of the seal member 40 according to the present embodiment. In the above-described embodiment, the first edge 61 and the second edge 62 are formed in straight lines, while the third edge 63 and the fourth edge 64 are formed in straight lines. As illustrated in FIG. 12, the first edge 61 and the second edge 62 may be formed in curves, and the third edge 63 and the fourth edge 64 may be formed in curves. Also in the present embodiment, since the first portion 51 and the second portion 52 are strip-shaped, it is possible to sufficiently generate the elastic force Fe for reducing the frictional force F.

### [5] Fifth Embodiment

A fifth embodiment will be described. In the following description, the same components as those in the above-described embodiment are designated by the same reference numerals, and the description thereof will be simplified or omitted.

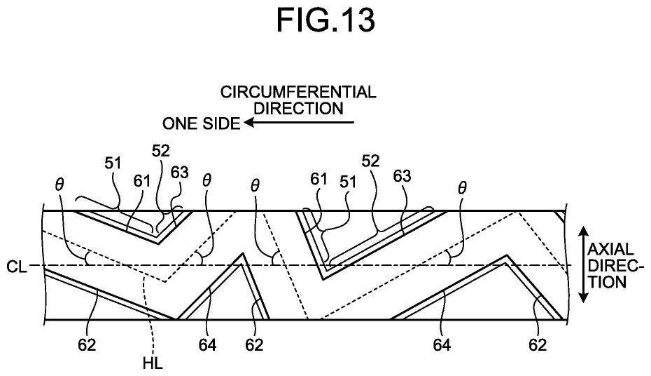

FIG. 13 is an enlarged perspective view of a part of the seal member 40 according to the present embodiment. In the above embodiment, the protrusions 50 are provided in a zigzag at a uniform pitch in the circumferential direction of the central axis CX. As illustrated in FIG. 13, the protrusions 50 may be provided in a zigzag with a non-uniform pitch in the circumferential direction of the central axis CX.

For example, the inclination angle θ of the center line HL may be an angle mutually different for each of the plurality of first portions 51 arranged in the circumferential direction. The inclination angle θ of the center line HL may be an angle mutually different for each of the plurality of second portions 52 arranged in the circumferential direction. Furthermore, the first edges 61 may have mutually different lengths and the second edges 62 may have mutually different lengths, for each of the plurality of first portions 51 arranged in the circumferential direction. The third edges 63 may have mutually different lengths and the fourth edges 64 may have mutually different lengths, for each of the plurality of second portions 52 arranged in the circumferential direction.

### [6] Other Embodiments

In the above-described embodiment, the first portion 51 and the second portion 52 are provided in plurality, alternately in the circumferential direction. The first portion 51 and the second portion 52 do not have to be continuously arranged in the circumferential direction, and the first portion 51 and the second portion 52 may be separated from each other. Furthermore, another first portion 51 may be arranged next to the first portion 51, or another second portion 52 may be arranged next to the second portion 52.

### REFERENCE SIGNS LIST

1 SWIVEL JOINT
10 ROTOR
11 HOLE
12 GROOVE
20 SHAFT
30 OIL PASSAGE
30A OIL PASSAGE
30B OIL PASSAGE
30C OIL PASSAGE
30D OIL PASSAGE
31A ANNULAR OIL PASSAGE
31B ANNULAR OIL PASSAGE
31C ANNULAR OIL PASSAGE
31D ANNULAR OIL PASSAGE
32A ROTOR PORT
32Aa ONE END
32Ab ANOTHER END
32B ROTOR PORT
32Ba ONE END
32Bb ANOTHER END
32C ROTOR PORT
32Ca ONE END
32Cb ANOTHER END
32D ROTOR PORT
32Da ONE END
32Db ANOTHER END
33A SHAFT PORT
33Aa ONE END
33Ab ANOTHER END
33B SHAFT PORT
33Ba ONE END
33Bb ANOTHER END
33C SHAFT PORT
33Ca ONE END
33Cb ANOTHER END
33D SHAFT PORT
33Da ONE END
33Db ANOTHER END
40 SEAL MEMBER
41 INNER CIRCUMFERENTIAL SURFACE
41A ONE END
41B ANOTHER END
42 OUTER CIRCUMFERENTIAL SURFACE
42A ONE END
42B ANOTHER END
43 UPPER SURFACE
44 LOWER SURFACE
50 PROTRUSION
51 FIRST PORTION
52 SECOND PORTION
53 CONTACT SURFACE
61 FIRST EDGE
62 SECOND EDGE
63 THIRD EDGE
64 FOURTH EDGE
65 FIFTH EDGE
66 SIXTH EDGE
67 SEVENTH EDGE
68 EIGHTH EDGE
71 RECESS
72 RECESS
100 LOWER CARRIAGE
101 TUBE
102 HYDRAULIC MOTOR
200 UPPER SWING BODY
201 TUBE
202 HYDRAULIC PUMP
203 HYDRAULIC OIL TANK
204 OIL PASSAGE
300 ROTATING MECHANISM
301 INNER RING MEMBER
302 OUTER RING MEMBER
401 INNER CIRCUMFERENTIAL RING MEMBER
402 OUTER CIRCUMFERENTIAL RING MEMBER
AX SWING AXIS
CL CENTER LINE
CX CENTRAL AXIS
HL CENTER LINE
MV WORKING VEHICLE

1. A seal member comprising:
an inner circumferential surface surrounding a central axis;
an upper surface connected to one end of the inner circumferential surface in an axial direction of the central axis;
a lower surface connected to another end of the inner circumferential surface in the axial direction; and
a protrusion that is provided continuously on the inner circumferential surface so as to surround the central axis and that includes a first portion inclined to the upper surface side toward one side in a circumferential direction of the central axis and a second portion inclined to the lower surface side toward the one side in the circumferential direction.

2. The seal member according to claim 1,
wherein the first portion and the second portion are provided in plurality, alternately in the circumferential direction.

3. The seal member according to claim 2,
wherein the first portion is defined by a first edge and a second edge inclined to the upper surface side toward the one side in the circumferential direction,
the second portion is defined by a third edge and a fourth edge inclined to the lower surface side toward the one side in the circumferential direction,
the first edge and the third edge are arranged on one end side of the inner circumferential surface from a center line between the one end and the other end of the inner circumferential surface,
the second edge and the fourth edge are arranged on the other end side of the inner circumferential surface from the center line, and
a boundary between the first edge and the third edge is arranged between boundaries between the second edges and the fourth edges, in the circumferential direction.

4. The seal member according to claim 3,
wherein the first edge and the second edge are parallel to each other, and
the third edge and the fourth edge are parallel to each other.

5. The seal member according to claim 4,
wherein the first edge and the second edge are formed in straight lines, and the third edge and the fourth edge are formed in straight lines.

6. The seal member according to claim 1, further comprising:
an inner circumferential ring member having the inner circumferential surface and the protrusion; and
an outer circumferential ring member arranged around the inner circumferential ring member and formed of a material having a hardness lower than a hardness of the inner circumferential ring member.

7. The seal member according to claim 6,
wherein the inner circumferential ring member is formed of synthetic resin, and
the outer circumferential ring member is formed of synthetic resin or rubber.

8. A swivel joint comprising:
a rotor;
a shaft disposed in a hole of the rotor; and
the seal member according to claim 1, disposed in a groove on an inner circumferential surface of the hole and configured to bring the protrusion into contact with the shaft to seal between the rotor and the shaft.
